(19) United States
(12) Patent Application Publication
(10) Pub. No.: US 2025/0273757 A1
(43) Pub. Date: Aug. 28, 2025

(54) METHOD OF DIRECT RECYCLING OF SPENT ELECTRODES

(71) Applicant: UCHICAGO ARGONNE, LLC, Chicago, IL (US)

(72) Inventors: OZGENUR KAHVECIOGLU, Naperville, IL (US); BRYANT POLZIN, Deerfield, IL (US); BEIHAI MA, Naperville, IL (US)

(73) Assignee: UCHICAGO ARGONNE, LLC, Chicago, IL (US)

(21) Appl. No.: 18/590,466

(22) Filed: Feb. 28, 2024

(51) Int. Cl. H01M 10/54; B32B 43/00; F27B 9/06; F27B 9/24; F27B 9/30

(52) U.S. Cl. CPC H01M 10/54; B32B 43/006; F27B 9/067; F27B 9/24; F27B 9/3005; F27B 2009/2484; F27M 2001/16

(57) ABSTRACT

The invention provides a method for recycling electrodes, the method comprising inductively heating the electrodes for a time sufficient to delaminate active material from current collectors underlying the active material. The invented process utilizes high frequency induction heating, which is a form of noncontact heating generated by the application of an electromagnetic field. The invention also provides a system for separating active material from current collectors of electrodes, the system comprising a particle transport mechanism enclosed in a housing; a first entry port for inserting electrodes into the housing and a second entry port for removing electrode components from the housing; and an inductive energy applicator for heating primarily interfaces comprising surfaces of the active material and surfaces of the current collectors opposing those active material surfaces.

### CONTRACTUAL ORIGIN OF THE INVENTION

This invention was made with government support under Contract No. DE-AC02-06CH11357 awarded by the United States Department of Energy to UChicago Argonne, LLC, operator of Argonne National Laboratory. The government has certain rights in the invention.

### BACKGROUND OF THE INVENTION

### 1. Field of the Invention

This invention relates to the recycling of batteries, and more specifically this invention relates to a method for direct recycling of electrodes.

### 2. Background of the Invention

Lithium-ion batteries (LIBs), with the unique features of high energy density, high charging efficiency and good cycle performance, are widely applied in portable electronics and electric vehicles. Automakers sold over 10 million EVs in 2022 (more than half of them in China) and global sales should top 14 million in 2023 according to the International Energy Agency (IEA). That growth is being accompanied by a surge in LIB production. The IEA says that in 2022 EV battery demand soared to 550 GWh, a roughly 65 percent rise from 2021.

LIBs play critical roles in reducing carbon dioxide pollution and achieving carbon net-zero by 2050. Spent LIBs have been one of the fast-growing and largest quantities of solid waste in the world. Spent graphite anode from LIBs accounting for 12 to 21 weight percent of those batteries, contains metals, binders, plastics, and flammable/toxic electrolytes. The vast majority of the end-of-life (EOL) lithium-ion batteries historically ended up in landfills, cause contamination of nearby soils, and underground water sources. The desire of developing innovative technologies for recycle spent electrode materials through reclaim and recovery of active materials from end-of-life batteries is ever increasing.

In a typical recycling process, end-of-life (EOL) battery packs are discharged and disassembled into modules or cells, and then shredded. Disassembly commonly refers to the separation of a battery's components into its anode, separator and cathode. The literature states that considerable research effort has been made toward disassembly relative to grinding/shredding. (E.g., Lithium-Ion Battery Recycling-Overview of Techniques and Trends, ACS Energy Lett, 2022, 7, 712-719.)

Disassembly is followed by electrolyte recovery and separation of active material from current collectors to remove/reclaim components including plastics, pouch material, and steel casings.

As a result, a feedstock of anode and cathode active materials still laminated with their current collectors is generated. This feedstock contains the most valuable components in a lithium-ion cell, and is often referred to as black mass. Black mass is the formless, powder-like materials collected from spent batteries excluding the metal parts (casings, foils). Black mass is a mixture of cathode powders, anode powders and the electrode formulation (carbon black, polyvinylidene fluoride (PVDF), polyacrylic acid (PAA)). It may include some copper and aluminum pieces not completely removed by such separation processes as froth flotation, and magnetic separation.

Active cathode materials include lithium nickel manganese cobalt oxide (NMC), lithium iron phosphate (LFP), lithium cobalt oxide (LCO) and lithium manganese nickel oxide (LMNO). An exemplary cathode electrode may comprise NMC laminated with, or otherwise overlaying aluminum foil.

Active anode materials include graphite, lithium titanium oxide, titanium metal, and silicon based anodes. An exemplary anode electrode may comprise graphite overlaying copper foil.

To reclaim active electrode materials with high purity for direct regeneration, separation of electrode (cathodes and/or anodes) materials from their current collectors are required. There are several methods for separating electrode materials from metal foils, including solvent-based electrode recovery and thermal binder removal. However, these processes may require the use of toxic solvents and high amounts of energy, while also resulting in low peeling-off (i.e., delamination) efficiency. Solvents also may deactivate the separated components such that subsequent reactivation processes or other pretreatment steps must be employed. For example, solvent based methods often result in corrosion of the current collector foil, such that the recovered foils cannot be used as is. Rather those current collectors need to be re-melted or otherwise purified, which adds to reclamation costs.

Other methods for separating anode and cathode materials, include density separation, froth flotation, and magnetic separation. However, state of the art processes require a complex set of separation procedures to produce clean streams of material, resulting in lower recovery rates and higher costs. It is thus extremely important to develop a simple organic solution-free, scalable, and cost-effective separation process to efficiently recover high-purity electrode materials as well as other battery materials so that different concentrated feedstock are provided for further direct regeneration and recovery processes.

A need exists in the art for a direct recycling process for battery electrodes. (Direct recycling refers to process wherein battery components are recycled and reused directly without modifying the chemical structures of these components.) Further, the process should render recyclable material ready for direct incorporation into new product, with purities on par with virgin materials.

### SUMMARY OF INVENTION

An object of the invention is to provide a method for recycling electrodes that overcomes many drawbacks of the prior art.

Another object of the invention is to provide a method for direct recycling of electrodes, such as anodes and cathodes. A feature of the invention is that no organic solvents are required. An advantage of the invention is the minimization of secondary waste streams.

Still another object of the invention is to provide a recycling material for incorporation into electrodes for lithium ion batteries (LIBs). A feature of the invention is that the recovered material has 95-98 percent of the material performance of virgin active material. An advantage of the invention is the expansion of overall feedstock in the market for this active material, therefore ameliorating the reliance on foreign sources of certain minerals such as graphite, cobalt, nickel, and lithium. Another advantage is the diversion of heretofore spent LIBs from landfills.

Yet another object of the invention is to provide a method for recovering active material from current collectors from the electrodes of spent LIBs. A feature of the method is the use of induction heating to delaminate the active material from the current collectors. An advantage of the invention is that it is performed at temperatures no higher than 250° C., rather between 12° and 250°-C, and preferably between 150° C. and 250° C.

Another object of the invention is to provide a completely dry process for harvesting black mass and current collectors from intact, end-of-life batteries. A feature of the invention is that only the surfaces of the battery casing and of the electrodes are heated. An advantage of the invention is that it yields primarily nonpartitioned (i.e., intact) current collectors and reusable black mass. As such, the invention provides a nondestructive method for harvesting electrode components for direct reuse.

Briefly, the invention provides a method for recycling electrodes, the method comprising inductively heating the electrodes for a time sufficient to delaminate active material from current collectors underlying the active material. The invented process utilizes high frequency induction heating, which is a form of noncontact heating generated by the application of an electromagnetic field. The process can be performed in ambient temperatures and pressures and in non-oxidizing atmospheres such as N₂, Ar, and He.

An embodiment of the invented method comprises reclaiming electrodes from intact EOL (e.g., spent) batteries and electrode manufacturing scraps, the method comprising discharging the EOL batteries, and inductively separating components of the electrodes, wherein metallic components comprising current collectors of the electrodes maintain their original manufactured dimensions. The recovery of originally dimensioned current collectors, (wherein the metallic foils are not cut, mutilated or otherwise broken apart) enhances the value of the invention, compared to one of the state-of-the-art systems wherein collectors are melted. Preferably, the intact batteries recycled here are devoid of organic electrolyte, such that any such electrolyte is first removed. The inventors have found that in instances where electrodes comprise copper foil laminated with graphite, no shredding is required. These instances mainly dealt with manufacturing scraps, as noted above.

Another embodiment of the method comprises discharging the electrodes, transforming the discharged electrodes into smaller but still laminated pieces; optionally washing the pieces, and then separating each of the components (e.g., current collectors, active materials, binder, and carbon black) of the pieces. The transforming step may include comminution such as shredding. This shredding step is often already accomplished inasmuch as spent battery feedstocks are usually shredded prior to separation procedures.

The invention also provides recovered active material derived from spent lithium ion batteries. The material is recovered via a direct recycling method to yield black mass retaining 95-100 percent of its original performance targets.

The invention provides a method for reclaiming active material and current collectors from electrodes, the method comprising heating only surfaces of the active material which oppose surfaces of the current collectors for a time sufficient to delaminate the active material from the current collectors.

The invention also provides a system for separating active material from current collectors of electrodes, the system comprising a particle transport mechanism enclosed in a housing; a first entry port for inserting electrodes into the housing and a second entry port for removing electrode components from the housing; and a no contact means for heating only surfaces of the active material which oppose surfaces of the current collectors. An exemplary no contact means is an inductive energy generator.

### BRIEF DESCRIPTION OF DRAWING

The invention together with the above and other objects and advantages will be best understood from the following detailed description of the preferred embodiment of the invention shown in the accompanying drawings, wherein:

FIG. 1 is a flow chart of a method for harvesting active material from electrodes, in accordance with features of the present invention;

FIG. 2 is a photograph of shredded anode active materials after being subjected to inductive heating, in accordance with features of the present invention;

FIG. 3A is a graph showing average discharge capacity versus cycle of anode graphite regenerated with the instant continuous method, in accordance with features of the present invention;

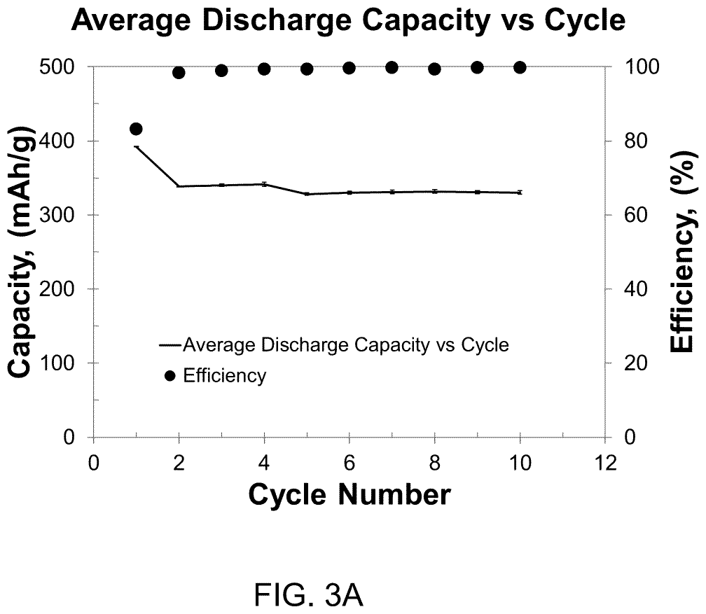

FIG. 3B is a graph showing average charge capacity versus cycle of anode graphite regenerated with the instant continuous method, in accordance with features of the present invention; and

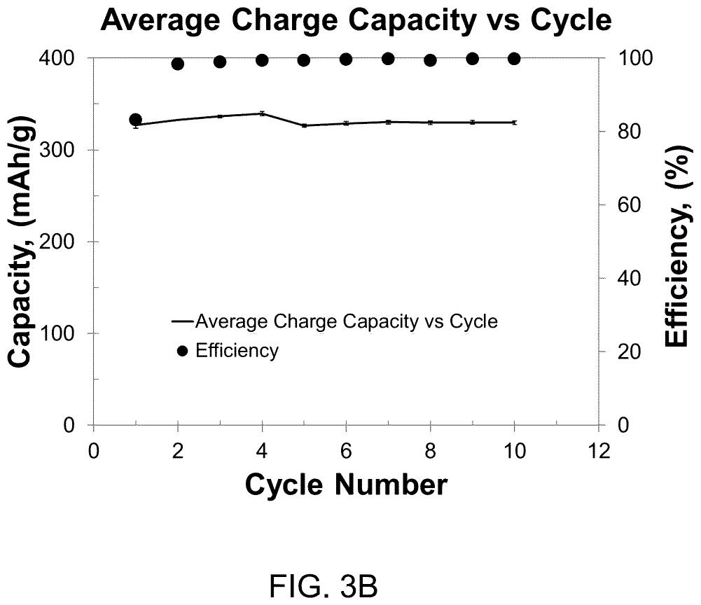

FIG. 4 is a schematic diagram of a continuous delamination device 5 for spent battery active materials from current collectors, in accordance with features of the present invention.

### DETAILED DESCRIPTION OF THE INVENTION

The foregoing summary, as well as the following detailed description of certain embodiments of the present invention, will be better understood when read in conjunction with the appended drawings.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

The following detailed description should be read with reference to the drawings in which similar elements in different drawings are numbered the same. The drawings, which are not necessarily to scale, depict illustrative embodiments and are not intended to limit the scope of the invention.

As used herein, an element or step recited in the singular and preceded with the word “a” or “an” should be understood as not excluding plural said elements or steps, unless such exclusion is explicitly stated. As used in this specification and the appended claims, the term “or” is generally employed in its sense including “and/or” unless the content clearly dictates otherwise.

Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The invention provides a method for direct recycling of electrodes. Both cathodes and anodes are candidates for recycling using this method. Different cathode and anode materials may be replenished via the invention. For example, cathodes comprising either NMC, LFP, LMNO, or LCO may be recycled.

This direct recycling invention provides enhanced energy-efficiency and generates less secondary pollution than hydrometallurgical or pyrometallurgical processes. The method does not require intensive energy or chemicals, avoids the destruction of spent battery materials, and directly rejuvenates degraded or spent electrode materials. For example, this new recycling process can output well-defined cathode materials with high value that can be directly used to fabricate new lithium batteries. Also, the regenerated active materials generated from the invented method are more valuable compared to elemental products from the aforementioned pyrometallurgical and hydrometallurgical recycling methods. In summary of this point, the invention reduces energy consumption and greenhouse gas emissions while avoiding the use of toxic chemicals.

This invention continuously recovers both active material and current collector foils (collectively “the electrode materials”). Active materials are separated from their underlying current collectors and both the active material and current collectors are subsequently recovered/reclaimed. Reclaimed electrode materials are reused without out further treatment in many instances, or otherwise with minimal treatments (e.g., gently grinding graphite before reuse).

Different cathode and anode materials may be replenished via the invention, even in the presence of common binders such as PVDF, carboxyl methyl cellulose/styrene butadiene rubber (CMC/SBR) and PAA. It is noteworthy that PVDF degrades at 180 C, such that it outgasses during inductive heat application of the invented process. Active anode material (e.g., graphite with 1-2 percent binder such as PVDF retains 95-99 percent of its chemical and physical characteristics after being reclaimed with the invented method. Recycling scrap graphite harvested by the method (and with no further treatment) performs at the same/similar cycling performance as the pristine graphite.

This new recycling process can output well-defined cathode materials with high value that can be directly used to fabricate new lithium batteries. Manufacturing scrap copper current foil recovered by the invented method may be merely wiped with a mild solvent (e.g., an alcohol such as ethanol) after being separated from its overlaying active anode material. In summary of this point, the invention generates ready to use electrode material without the need for thermochemical treatment, but rather mild physical manipulation. (Indeed, as noted supra, state of the art solvent treatment of separated battery components often results in deactivation of those components.)

Also, the regenerated active materials from direct recycling might be more valuable compared to elemental products from pyrometallurgical and hydrometallurgical recycling methods. In addition, it may also reduce energy consumption and greenhouse gas emissions while avoiding the use of toxic chemicals.

An embodiment of the invention provides a method for recovering current collectors (e.g., copper foil) from anodes via induction energy-induced delamination. During anode delamination by the invented high frequency induction heating (HFIH) process, two materials (1) graphite and (2) high purity copper foil are recovered. The recovered copper foil, which is free of copper oxide, can be used to make graphene infused advanced conductors. The method mixes and deforms the solid feedstocks without melting or external heat treating. The resulting conductivity of copper foil and wire harvested results in an increased conductivity of approximately 5 percent. Separately, upcycling of the copper foil may be used as a high-end product for other technologies than batteries.

An embodiment of the invention provides a solvent free, high throughput and induction heating (HFIH) process for the surface treatment, recycling, upcycling and reusing of spent Li-ion battery materials and delamination of battery materials from current collectors. Induction heating may be effected at frequencies ranging from 100 k Hz/sec to 1000 k Hz. Induction heating is utilized wherein the frequencies preferably range from 100 k Hz to 500 k Hz. The use of high frequency inductive radiation results in the surfaces of discrete electrode components, and the interfaces therebetween, being heated. The materials are heated for a time ranging from 10-30 seconds to 5-10 minutes. This compares to state of the art systems which heat the entire bulk of those materials for up to 300 minutes. For example, in the invented high frequency inductive heating (HFIH) process, energy delivered by electromagnetic fields focuses at the interface between the current collector foil and electrode (cathode or anode) materials. The difference in thermal expansion coefficients of these different materials at the interface drives the delamination at that interface. Relatively speaking, interior regions of the active material and the current collectors are not heated to a lesser degree than the interfaces. In summary of this point, the invented method exploits the different heating rates of the components to get preferential delamination.

In an embodiment of the invention, inductive energy is applied to separate the active material from anodes and thermal energy is applied to separate the active material from cathodes.

No other changes are observed in the time frame required for the delamination process to occur. For example, full dry cell induction heating only effected the conductive copper and graphite (anode); the cathode was not affected (at least visually) and stayed intact. In cathodes of LIBs, the particle core (e.g. lithium metal oxides are transparent to inductive heating and so do not heat up. As such its physical properties are preserved.)

An embodiment of the invention is that it is devoid of the use of any polar or nonpolar fluids.

The invented process utilizes high frequency induction heating, which is a noncontact heating by electromagnetic field. Preferable frequencies range between 100 KHz and 500 kHz Hz/sec and are applied for between 10 seconds and 500 seconds. Optimal conditions for the delamination of anodes include 1.35 KW, 27A, 200 kHz, all effected in a one-step heating process, all within 2-3 minutes. Delamination occurs within 20 seconds from the start of the heating process.

When combined with inert atmosphere (i.e., a nonoxidizing atmosphere) high purity spent active materials and pristine (not-oxidized) current collector foils are recovered.

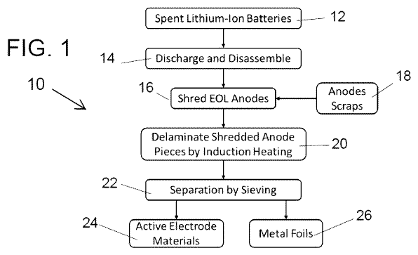

FIG. 1 is a flow chart of the invented method, generally designated by the numeral 10. A supply of spent lithium-ion batteries is initially provided 12. The supply is initially discharged and disassembled 14 so that primarily the electrode active material/current collector remains.

This remaining material may be subjected to shredding 16 and may be supplemented with anode scraps 18 from either virgin processing operations or other feed streams. A commonly owned battery shredding process guarantees particles being generated with certain aspect ratios that commonly owned property embodied in U.S. patent application Ser. No. 17/180,621, and incorporated herein by reference.

The resulting shredded material represents composite electrode pieces consisting of active material laminated or otherwise overlaid onto current collectors. For example, the composite pieces may be anode material comprising graphite adhered to copper foil. If cathodes are being delaminated, the composite pieces may comprise lithium metal oxide (Metal=Ni, Mn, Co, Fe, Al and etc.) on Aluminum foil. The aluminum foil may be carbon-coated or pure Al.

These composite, shredded pieces are subjected to an inductive heating process 20, which may comprise heating the composites to up to 250° C. for a time sufficient to cause delamination of the active material from its respective current collector. The delamination occurs as a result of the difference in thermal expansion between the active material and the metal foil. Generally, in the case of anode delamination, the active material (e.g., graphite) expands less rapidly than the underlying copper foil. It is noteworthy that other components of LIBs, such as PVDF binders, may evaporate during the heating process and are carried away by inert gas purging the system.

Depending on the extent of HFIH and other process conditions and time of heating, there may be residual PVDF in the delaminated graphite. As such, the invention enables the generation of graphite already containing PVDF, thereby obviating the need for replenishing the graphite with PVDF before the graphite is integrated back into batteries.

An embodiment of the invention does not require shredding of battery components prior to the delamination step. Preferably this embodiment deals with EOL batteries or manufacturing-scrap cells, the latter of which are dry (i.e., do not contain electrolyte). For example, prior to delamination, the electrolyte is removed. At the most, disassembly of the battery is all that is required, such that the battery components are recovered nearly intact but not ground up or otherwise mutilated via shredding. This assures that current collectors are harvested intact and in their original shape and sizes. This eliminates the need to recast otherwise melted collectors prior to reincorporation into batteries.

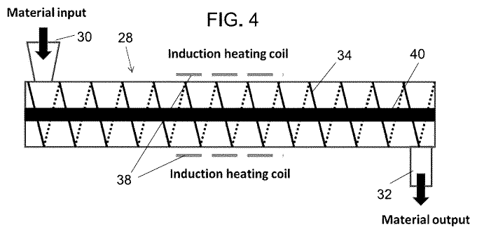

Upon completion of delamination, the two components are separated in a sieving operation 22. Sieve sizes may vary, with a preferable range of between 100 mesh (150 μm) and 10 mesh (2000 μm). The sieve(s) may be shaken or otherwise agitated to facilitate separation of the active material filtrate from the metal foil retentate. Optionally, a nitrogen purge or negative pressure may be used to optimize separation. The nitrogen purge may be applied at positive pressure at the fluid ingress port 30. Alternatively, a negative pressure (e.g., vacuum) may be applied at an egress point (see element number 32 in FIG. 4) to facilitate evacuation of liberated material from a reactor (see element number 28 in FIG. 4). The fluid ingress means may also serve as a solid material ingress port and the fluid egress means may also serve as a solid material egress port. In an embodiment of the invented process, the heating step comprises simultaneously subjecting the pieces to inductive energy and a materials separation process selected from the group consisting of magnetism, pressure differential, floatation, sieving, and combinations thereof.

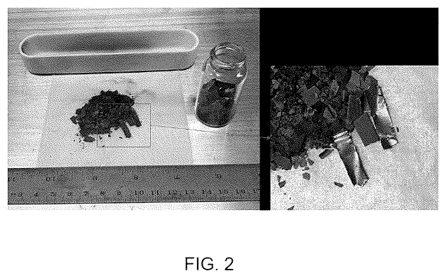

The final product, active electrode materials 24 and current collectors 26 are subsequently recovered and repurposed. Examples of such recovered material and intact current collectors are shown in FIG. 2. FIG. 2 is a photograph of shredded anode active materials recovered after being subjected to inductive heating, in accordance with features of the present invention. Two pieces of shredded Cu foils were placed alongside the recovered active anode material for comparison. The photograph is evidence of the invention's ability to recover current collectors in a nearly intact state, which is to say, with minimal partitioning, breaking apart, or reduction of the current collector's original configurations and/or dimensions.

It is noteworthy that after delamination, the materials and current collectors often need not be subjected to sieving or magnetic separation, given the intact nature of the foils so harvested.

Methods for separation of these two components depend on the starting material, i.e., if the starting material is dry manufacturing scrap or wet end of life cells. Air classification, density separation (floatation), and mechanical separation (e.g., magnetism, sieving) to separate the graphite material and copper foil. Pressure differentials are suitable. For example, while an inert atmosphere may be maintained at the center of the reaction chamber, negative pressure may be imposed at the downstream end of the chamber to facilitate product collection in a continuous harvesting process.

There may be an electrolyte wash step in the process in three different instances: Washing may occur before delamination in the cell; washing may occur after delamination and followed by shredding; or washing may occur after shredding but before delamination.

In an embodiment of the invention, the method is conducted in completely dry phase.

In another embodiment of the invention, alcohol or water may be utilized after the electrode material is subjected to a constituent separation process.

The method results in nearly 95 percent of original material being retained. Also, given the paucity of organic solvents, the chemical activity and physical characteristics of the separated electrode materials 24 and metal foils 26 are on par with virgin constituents.

FIG. 4 is a schematic diagram of a continuous delamination method for spent battery active materials from current collectors. Specifically, FIG. 4 depicts a continuous feed induction heating reactor 28 with screw conveyor 34. The housing (conveyer cast) may be made of alumina or quartz. The conveyor may be made of graphite or other conductive material. This facilitates the positioning of the actual heating source (e.g., an induction heating coil 38) positioned outside of the reactor. While the coil is seen not contacting the exterior of the reactor 28, the coil may in some instances be in contact with the reactor.

Using this continuous reactor configuration, intact batteries may be placed therein. Induction heating may be applied to liberate full length current collector metals (e.g., copper strips). This delamination may be effected at temperatures of approximately 200° C. In this instance, electrodes are first shredded and then are contained within the housing wherein the inductive energy is applied to exterior surfaces of the housing. The housing maybe maintained at ambient temperature and pressure.

After delamination, both black mass and current collector metals pass through a means of egress 32. Then, the reactor may be heated to a temperature suitable to melt cathode current collector metals (e.g., aluminum), those metals subsequently leaving the reactor 28 via the means of egress 32.

The conveyor 34 may be actuated by a longitudinally extending shaft 40, (e.g., a screw conveyor) which spans the length of the reactor 28. The dotted lines shown in the figure depict the emf coils. The length of the dotted lines represent the extent of the hot zone.

Generally, the reactor 28 may be confined or otherwise sequestered in a controlled atmosphere.

### Induction Heating Detail

Intense heat is delivered to the interface of high conductive current collector foils and the less conductive active coating materials. The frequency of the electromagnetic radiation maybe selected from a wide range, for example from 100 Hz to 1000 kHz. The frequency will be fine-tuned depending on the constituents of the battery.

The application of the electromagnetic radiation which manifests as inductive heating causes a large temperature gradient. The gradient is established relatively quickly (within o.01 to 100 seconds) compared to methods of heating utilized in state of the art battery recycling processes. The imposition of this sudden temperature gradient results in delamination of active coating materials, without having to increase the overall temperature of the materials substantially. The entire process, from application of inductive energy to delamination of material occurs between 2 and 10 minutes.

The use of inductive energy results in energy savings of between $0.10 and $0.50 per kilogram of black mass regenerated.

In summary, this invention comprises a direct recycling and method for recovery of electrodes of Li ion batteries (LIBs), more specifically, a cost-effective and fluid-free method for delamination of spent electrode materials from current collector strips of end of life Li ion batteries. The method can be applied for efficient high-throughput direct recycling of LIBs with better energy saving and improved greenhouse gas reduction.

When the invented process is performed on manufacturing scrap, the result is the generation of high purity electrode active materials and pristine (not-oxidized) current collector foils. Inasmuch as the reversible capacities of synthetic and natural graphite is 300 mAh/g and 330 mAh/g respectively, any reharvested graphite that displays capacities at or above 300 mAh/g is preferred.

The example below discusses the repurposing of LIB anode material, that material comprising active anode material (e.g., graphite) and metal current collector foil (copper). However, a myriad of battery constituents may be repurposed with the invented method, those constituents including, but not limited to cathode black mass material such as NMC, LCO. LFP, LNMO, LMO, anode black mass material such as Graphite, lithium, LTO, Si/C composites and current collectors selected from the group consisting of copper and alloys thereof, Al and alloys thereof, Ni and alloys thereof, Ti and alloys thereof, stainless steel, metalized polymer foil and graphite/carbon foil, and combinations thereof.

### Example 1

FIGS. 2A-C shows photographs of three samples of active anode coating materials and current collector Cu foils after delamination by induction heating processing. The electromagnetic frequencies utilized in these three separations ranged from 150 k Hz/sec to 250 k Hz/sec.

Table 1 shows the input mass versus recovered output mass in terms of grams. The respective weights and corresponding recovery ratios of the active material and foils are listed, wherein “Initial Wt” refers to weight of spent anode strips before inducting heating treatment. “Final Wt” refers to total remaining weight of spent anodes strips after induction heating treatment, “BM Wt” refers to weight of recovered black mass, and “CF Wt” refers to weight of recovered current collector Cu foils.

TABLE 1
Weights and recovery ratios of four samples of spent
anode delaminated by induction heating process:

| | Initial Wt | Final Wt | BM WT | CF Wt | Recov. Rate |
|---|---|---|---|---|---|
| Sample # | (g) | (g) | (g) | (g) | % |
| 1 | 3.01 | 2.91 | 1.96 | 0.94 | 94.69 |
| 2 | 3.05 | 2.95 | 2.18 | 0.77 | 95.61 |
| 3 | 3.02 | 2.94 | 2.02 | 0.90 | 95.28 |
| 4 | 3.01 | 2.92 | 2.21 | 0.71 | 96.09 |
| Average | 3.02 | 2.93 | 2.09 | 0.83 | 95.42 |

The recovered active anode materials accounted for approximately 95 percent of the total weight of the active coating materials on current collector foils. This compares with zero percent for state of the art pyro processes and 80 percent for hydrometallurgical processes.

Table 2 below shows the conductivity of recovered graphite generated by the invented recycling method, whereas Table 3 shows the performance of virgin materials.

Specifically, Table 2 shows the charge and discharge capacities for two samples of recovered electrode components, specifically graphite. P1 and P2 designate two samples generated by the invented method. Charge and discharge capacities are designated in milli-Amp hours per gram (mAh/g).

TABLE 2

| | | | | Standard |
|---|---|---|---|---|
| mAh/g | P1 | P2 | Average | Deviation |
| Reversible C Cap | 333 | 333 | 333 | 0 |
| (mAh/g) | | | | |
| Reversible D Cap | 338 | 339 | 339 | 0 |
| (mAh/g) | | | | |

Table 2 shows that the average reversible charging and discharging capacity for the recovered black mass is 333 mAh/g and 339 mAh/g, respectively. This compares to 345 mAh/g and 333 mAh/g of virgin material, thus evidencing a charge capacity of the recovered material that is 96.5 percent of the original.

Table 3 (below) shows the electrochemical performance of commercially available virgin graphite. Specifically, Table 3 shows the charging and discharging capacity of six different anode black mass materials. The half-cell voltage window (V) for this data was 1.5 to 0.0.

TABLE 3
Materials Screening Results

| | Reversible Charge Capacities at |
|---|---|
| Sample | C/10 (RT) (mAh/g) |
| 1-Natural Graphite | 345 |
| 2-Natural Graphite | 262 |
| 3-Artificial Graphite | 336 |
| 4-Natural Graphite | 326 |
| 5-Artificial Graphite | 306 |
| 6-Artificial Mesocarbon Microbeads | 306 |

All of the six samples are commercially available. Specifically, samples 1, 2 were natural graphite and experimental graphite from Phillips, Samples 3 and 5 was artificial graphite from Hitachi, Sample 4 was natural graphite from Superior Graphite (Chicago), and Sample 6 was artificial mesocarbon microbeads carbon from Gelon (ShanDong, China).

Among other embodiments of the invention described supra, a method for reclaiming electrodes from intact batteries is provided, the method comprising discharging the intact batteries, positioning the discharged intact batteries into a reactor, the reactor defining a first housing, separating components of the electrodes while the electrodes reside within the housing, and removing the separated components from the housings. The separated components include metallic current-collectors and the metallic current collectors are removed still intact. The separating step comprises heating solely the surfaces of the washed electrodes to between 18° and 250° C.

The invention utilizes a no contact heating method such as the imposition of inductive energy. The inductive energy is applied to exterior surfaces of the housings. This no contact heating feature allows_separation occurs at ambient temperature and pressure. As such, the step of separation comprises heating only the surfaces of the electrodes. This step of delamination comprises delivering energy at the interface of current collectors and active electrode materials, without physically contacting the current collectors and active materials.

The batteries typically would contain electrolyte materials selected from the group consisting of polar solvent, non-polar solvent, and a combination thereof. However, intact manufacturing scrap may not contain electrolyte.

It is understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those skilled in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all sub ratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

1. A method for reclaiming active material and current collectors from electrodes, the method comprising heating surfaces of the active material which oppose surfaces of the current collectors for a time sufficient to delaminate the active material from the current collectors.

2. The method as recited in claim 1 wherein only the surfaces are heated to between 18° and 250° C.

3. The method as recited in claim 1 wherein the heating step comprises subjecting the electrodes to inductive energy.

4. The method as recited in claim 3 wherein the electrodes are first shredded and then are contained within a housing wherein the inductive energy is applied to exterior surfaces of the housing.

5. The method as recited in claim 4 wherein the housing is maintained at ambient temperature and pressure.

6. The method as recited in claim 1 wherein the heating occurs in an inert atmosphere selected from the group consisting of nitrogen, argon, helium, and combinations thereof.

7. The method as recited in claim 3 wherein induction frequencies above 100 kHz and below 1000 kHz are utilized.

8. The method as recited in claim 1 wherein interior regions of the active material and the current collectors are not heated.

9. The method as recited in claim 3 wherein the heating step comprises simultaneously subjecting the pieces to inductive energy and a materials separation process selected from the group consisting of magnetism, pressure differential, floatation, sieving, and combinations thereof.

10. The method as recited in claim 3 wherein the inductive energy is applied to separate the active material from anodes and thermal energy is applied to separate the active material from cathodes.

11. The method as recited in claim 10 wherein the separated active material from anodes is graphite and the separated graphite exhibits an average charge capacity of 328 mAh/g and an average discharge capacity of 394 mAh/g.

12. A system for separating active material from current collectors of electrodes, the system comprising:
a) a reactor comprising a particle transport mechanism enclosed in a housing;
b) a first entry port for inserting electrodes into the housing and a second entry port for removing electrode components from the housing; and
c) a no-contact heater circumscribing the housing for heating only surfaces of the active material which oppose surfaces of the current collectors.

13. The system as recited in claim 12 further comprising a fluid ingress means and a fluid egress means for establishing an inert atmosphere within the housing.

14. The system as recited in claim 13 wherein the inert atmosphere comprises nitrogen gas, helium gas, argon gas, and combinations thereof.

15. The system as recited in claim 12 wherein the material transport mechanism comprises a screw conveyor which spans the length of the housing.

16. The system as recited in claim 12 further comprising a device for separating the current collector from the active material, said device situated exterior of the housing.

17. The system as recited in claim 16 wherein the separation device utilizes a physical manipulation force selected from the group consisting of magnetism, negative pressure, flotation, sieving, and combinations thereof.

18. The system as recited in claim 13 wherein the fluid ingress means also serves as a solid material ingress port and the fluid egress means also serves as a solid material egress port.
